(19) United States
(12) Patent Application Publication
(10) Pub. No.: US 2009/0274094 A1
(43) Pub. Date: Nov. 5, 2009

(54) ADVERTISING SUPPORT FOR A PLURALITY OF SERVICE NETWORKS BY A WIRELESS ACCESS POINT

(75) Inventor: DARWIN A. ENGWER, PORTLAND, OR (US)

Correspondence Address: TROP, PRUNER & HU, P.C., 1616 S. VOSS ROAD, SUITE 750, HOUSTON, TX, 77057-2631, US

(73) Assignee: NORTEL NETWORKS LIMITED, ST. LAURENT (CA)

(21) Appl. No.: 12/344,639

(22) Filed: Dec. 29, 2008

Related U.S. Application Data
(60) Provisional application No. 61/049,224, filed on Apr. 30, 2008.

(51) Int. Cl. H04W 88/08

(52) U.S. Cl. 370/328

(57) ABSTRACT

To advertise capabilities of a wireless access point, the wireless access point communicates, to a mobile station, messages at plural levels of detail to advertise that the wireless access point supports a plurality of service networks. The messages at the plural levels of detail include a first message indicating that the wireless access point supports multiple service networks, and a second message containing information identifying the plurality of service networks.

### CROSS-REFERENCE TO RELATED APPLICATIONS

This claims the benefit under 35 U.S.C. §119(e) of U.S. Provisional Application Ser. No. 61/049,224, entitled “Method for Efficient Service Advertisement in a Wireless Network,” filed Apr. 30, 2008 (Attorney Docket No. 19461SSUS01P), which is hereby incorporated by reference.

### TECHNICAL FIELD

The invention relates generally to advertising that a wireless access point supports a plurality of service networks.

### BACKGROUND

Wireless access networks are increasingly becoming popular as the preferred technique for performing communications and/or accessing online resources, such as informational websites, online stores, and so forth. One popular type of wireless access network is the Wi-Fi network (also referred to as the wireless local area network or WLAN), as defined by various IEEE (Institute of Electrical and Electronics Engineers) 802.11 standards. Wi-Fi networks can be provided in airports, hotels, stadiums, retail outlets, and so forth.

A Wi-Fi network is made up of a collection of access points with corresponding coverage areas. A user terminal within a particular one of the coverage areas is able to perform wireless communication with the corresponding access point, which enables the user terminal to establish communications sessions or to access network resources, such as resources available on the Internet. Traditionally, such a wireless access network is connected to a single service network managed by a service provider. Users can subscribe to services provided by the service network, such as by entering into long-term subscription agreements or by paying for short-term (e.g., 24-hour) subscriptions. According to the 802.11 standards, service networks are referred to as subscription service provider networks (SSPNs). An SSPN is a network controlled by a subscription service provider (SSP) with which a user of a user terminal has an established relationship. The SSPN maintains user subscription information.

More recently, efforts are underway to define mechanisms to allow an access point, and by extension an entire wireless access network, to support multiple service networks (e.g., multiple SSPNs). However, conventional solutions do not address how information relating to the multiple service networks supported by any wireless access point can be efficiently advertised to user terminals.

### SUMMARY

In general, according to an embodiment, a method to advertise capabilities of a wireless access point includes communicating, from the wireless access point to a mobile station, messages at plural levels of detail to advertise that the wireless access point supports a plurality of service networks.

Other or alternative features will become apparent from the following description, from the drawings, and from the claims.

### BRIEF DESCRIPTION OF THE DRAWINGS

FIG. 1 is a block diagram of an exemplary communications network in which some embodiments of the invention can be incorporated.

FIG. 2 is a flow diagram of a process of advertising information relating to multiple service networks supported by a wireless access point to a mobile station, in accordance with an embodiment.

FIG. 3 is a block diagram of a wireless access point according to an embodiment.

### DETAILED DESCRIPTION

In the following description, numerous details are set forth to provide an understanding of some embodiments. However, it will be understood by those skilled in the art that some embodiments may be practiced without these details and that numerous variations or modifications from the described embodiments may be possible.

In accordance with some embodiments, a mechanism or technique is provided to efficiently advertise that a wireless access point of a wireless access network is able to support multiple service networks. A “service network” refers to a network to which a user can subscribe (either on a long-term or short-term basis) to access services provided by the service network. For example, once the user has subscribed to the service network, the user will be able to access network resources (e.g., Internet websites, online stores, etc.) and/or to perform network communications (e.g., e-mail, text chat, etc.). Note that user subscription is not the only basis for access to a particular network—it is just one example. Another example involves a wireless access network located in an airport. The wireless access network may deliver, for example, four service networks: below the floor operations (e.g., luggage handling), airline gate terminal operations, retail establishment operations, and public access. Within the latter category, the public access may embody several service networks with corresponding service subscription providers. For the other service network categories, the user terminals will typically/primarily select the appropriate service network based on its wireless network ID (identifier) string (called the Service Set Identifier, SSID). However, that does not eliminate the potential need for such service networks to advertise additional information to its service users. Current access points advertise the characteristics of the wireless access network itself. However, some embodiments of the invention allow characteristics of the service network to be advertised. For example, a dedicated service network may benefit from low duty cycle advertising of security information necessary for the corresponding user terminals to have available and decode prior to use of the network.

The service network can maintain credentials of a user such that the user can be authenticated prior to providing access of services to the user. Multiple service networks can be associated with multiple service providers. A user may be a subscriber of just one of the service networks, but not of the other service networks. Alternatively, a user may be a subscriber of multiple service networks. By advertising the service networks supported by a wireless access point, a user terminal is able to obtain information about what service networks are available, and the user terminal can select an appropriate one of the service networks to access.

The mechanism to efficiently advertise multiple service networks according to some embodiments involves use of messages at multiple levels of detail to advertise the service networks supported by the wireless access point. The messages at the multiple levels of detail can include a first message containing a short indicator (e.g., a one-bit flag) indicating that the wireless access point supports multiple service networks, and a second message containing more detailed information identifying the multiple service networks that are supported by the wireless access point. The first message having less detail (and therefore having a smaller size) is transmitted more frequently than the second message, which is transmitted less frequently. By transmitting the second message (which is larger in size) less frequently, more efficient usage of the wireless bandwidth between wireless access points and mobile stations can be achieved.

In another embodiment, instead of advertising multiple service networks at multiple levels of detail, “enhanced capabilities” of a wireless access point can be advertised. “Enhanced capabilities” refers to capabilities of a wireless access point other than services provided by the wireless access point to enable wireless attachment by mobile stations and communications between the mobile stations and a network connected to the wireless access point. Examples of enhanced capabilities include web services, location services, emergency services, and so forth. A first message at a first level of detail can specify that the wireless access point supports multiple enhanced capabilities, and a second message at a second level of detail can describe the details of the multiple enhanced capabilities.

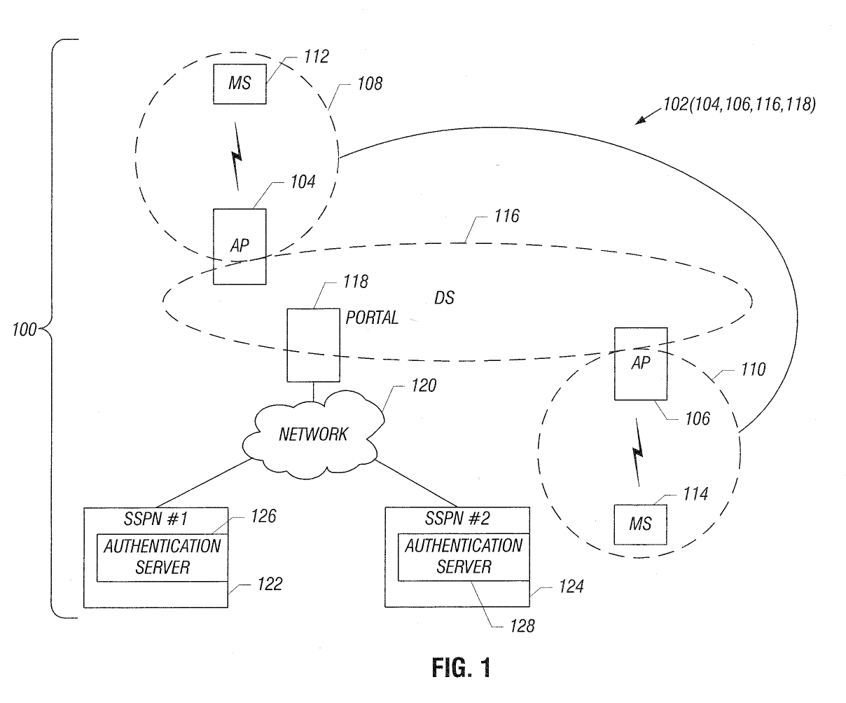

FIG. 1 illustrates an exemplary communications network 100 that includes a wireless access network 102 that has a collection of access points 104, 106, a distribution system 116, and a portal 118. Although just two access points 104, 106 are depicted as being part of the wireless access network 102, it is contemplated that the wireless access network 102 can include more access points. A “wireless access point” or “access point” refers to a device having wireless (e.g., radio) transceivers that enable wireless mobile stations to wirelessly connect to the device for the purpose of accessing a network resource.

Each access point 104, 106 delivers wireless access service to a respective coverage area 108, 110. A mobile station within a particular coverage area is able to wirelessly communicate with the corresponding access point. For example, a mobile station 112 is located in the coverage area 108 of the access point 104, while a mobile station 114 is located in the coverage area 110 of the access point 106. A “mobile station” refers to any user terminal that is able to wirelessly communicate with a wireless access point. Examples of mobile stations include computers, personal digital assistants (PDAs), mobile telephones, and so forth. Alternatively, the stations 112, 114 can be fixed rather than mobile station.

In some embodiments, the wireless access network 102 can be a Wi-Fi network (also referred to as a wireless local area network or WLAN), which is defined by various IEEE (Institute of Electrical and Electronics Engineers) 802.11 standards, including 802.11a, 802.11b, 802.11g, 802.11n, 802.11u, and 802.11v. In accordance with some embodiments, reference to “Wi-Fi” or “WLAN” or “wireless local area network” refers to any wireless access network that employs any of the IEEE 802.11 standards, including currently existing standards as well as future standards that evolve from the current standards. Although reference is made to “Wi-Fi” or “WLAN” in some embodiments, it is noted that the same or similar techniques can be applied to other wireless access technologies.

According to the IEEE 802.11 standards, an access point (such as access point 104 or 106) together with its associated stations (including mobile stations) is referred to as a basic service set (BSS). An extended service set (ESS) is a set of one or more interconnected BSSs. Thus, in the example of FIG. 1, the basic service sets created by access points 104 and 106 together are part of an ESS.

FIG. 1 also shows a distribution system (DS) 116, which refers to a component (which can be the physical infrastructure and/or a virtual implementation) for connecting multiple access points together. The wireless access network 102 is able to connect through a portal 118 to an external network 120, which can be the Internet, a local area network, a wide area network, or other type of network.

Service networks 122 and 124 are accessible by the wireless access network 102 over the network 120. In one embodiment, the service network 122 is referred to as SSPN #1 (subscriber service provider network #1), and service network 124 is referred to as SSPN #2 (subscriber service provider network #2). Each service network 122 and 124 includes an authentication server 126 and 128, respectively, to store user credentials and other subscription information for authenticating users and to indicate what services users have subscribed to.

Although just two service networks are depicted in FIG. 1, it is noted that in other implementations, additional service networks can be accessible by the wireless access network 102.

Each access point 104 or 106 is configured with information about the service networks 122 and 124, such that each access point 104 or 106 is able to advertise information regarding the service networks that the access point is able to support. The access point is able to advertise information regarding service networks supported by the access point by sending messages at multiple levels of detail, where less detailed messages (messages of smaller size) are sent more frequently, while more detailed messages (messages of larger size) are sent less frequently.

The arrangement of network nodes depicted in FIG. 1 is provided for purposes of example. In other implementations, other arrangements can be employed.

In accordance with some embodiments, a mobile station is able to learn information about service networks supported by an access point in a passive manner (i.e., the mobile station does not have to first transmit a query to the access point to obtain information about service networks supported by the access point). By not requiring mobile stations to issue queries to obtain information regarding supported service networks, more efficient utilization of the wireless bandwidth is provided. For example, in a stadium environment, where there can be tens of thousands of users, requiring each user to submit queries to obtain information about supported service networks would result in a large amount of traffic just for the purposes of determining service network availability and/or characteristics.

A further enhancement provided by some embodiments is that detailed messages that are large are sent less frequently. To accomplish this, a wireless access point can send a first message that contains a simple indicator of whether or not the access point supports multiple service networks. The indicator can be a single-bit flag, for example, where a first value indicates support for multiple service networks, while a second value indicates no support for multiple service networks. The first message can also contain time information to indicate when the mobile stations associated with the access point can expect to receive a second, more detailed message, which contains information regarding the supported service networks. The second message is sent less frequently than the first message. Each time the first message is transmitted, the time information can be iteratively decremented until such time as the second message is actually sent, after which the time information can be reset to its initial value.

Although reference is made to messages at two levels of detail, it is noted that in other embodiments, messages at three or more levels of detail can be employed.

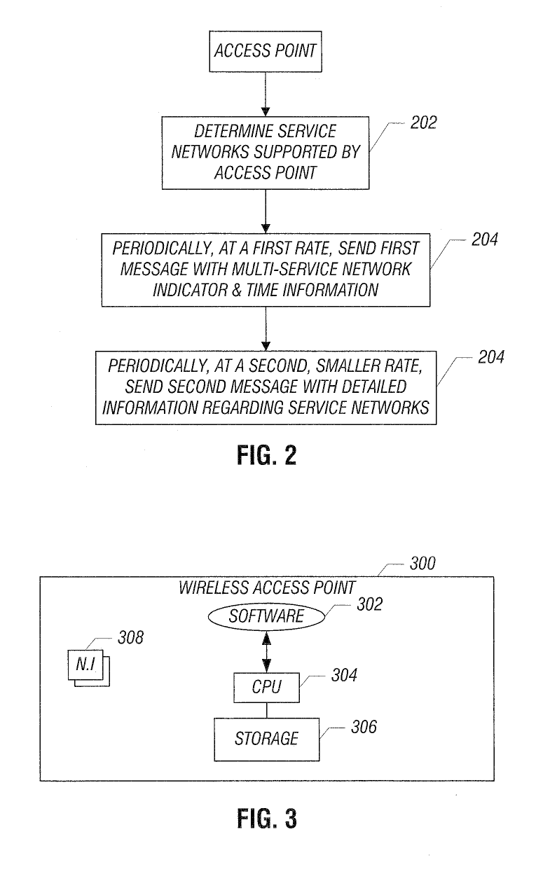

FIG. 2 shows a process performed by an access point, according to an embodiment. The access point initially determines (at 202) the service networks that are supported by the access point. In one example, the access point can be programmed with configuration information regarding the service networks that are supported by the access point. Alternatively, the access point can retrieve such information from a remote source.

Next, the access point periodically sends (at 204) the first message containing a multi-service network indicator (to indicate whether or not the access point supports multiple service networks) and time information to indicate when mobile stations can expect to receive the more detailed second message containing detailed information regarding supported service networks. The time interval at which the first message is periodically sent can be predefined.

In some implementations, the time information contained in the first message can be in the form of a time interval value. The second message would be sent at that precise time interval after the first message. Note that the first message can be a broadcast message, such as part of a beacon frame. In other implementations, the time information can have other formats.

The access point also periodically sends (at 206) the second message (also referred to as a “full advertisement message”) containing detailed information regarding service networks (including identification information of the service networks). The full advertisement message is sent less frequently, and the time interval at which the full advertisement message is periodically sent can be predefined to be larger than the time interval at which the first message is periodically sent. The full advertisement message can also be sent as part of a beacon frame.

The periodically sent full advertisement messages are sent at time points indicated by the periodically sent first messages. In response to each first message, a mobile station knows exactly when the mobile station needs to listen for the full advertisement message. The mobile station can then optionally enter a sleep or power saving mode, and then wake up just in time to receive the full advertisement message. As a result, battery life of the mobile station can be saved, while at the same time, the mobile station can relatively quickly and efficiently learn about available service networks in a passive manner. The full advertisement message can contain information for multiple service networks in one message, and since that message is sent at a low rate, the message can be quite large, containing much detail, and in some cases can include everything the mobile station would ever want to know about the service network. This enables the mobile station to avoid requesting additional information later.

In some embodiments, the full advertisement message can be in the form of a Generic Advertisement Service (GAS) query response, as defined by IEEE 802.11u.

Although FIG. 2 depicts just two levels of detail for messages sent by the access point to advertise supported service networks, it is noted that alternative embodiments can employ more than two levels of detail. In such other embodiments, a message having an intermediate detail level (between the detail levels of the first and full advertisement messages) can be sent at another rate that is less than the rate at which the first messages are sent but greater than the rate at which the full advertisement second messages are sent.

The tasks performed in FIG. 2 by the wireless access point can be performed by a wireless access point 300 depicted in FIG. 3. The wireless access point 300 can be one of the access points 104 and 106 depicted in FIG. 1. The wireless access point 300 includes software 302 that is executable on one or more central processing units (CPUs) 304 to perform tasks of the access point 300, including the tasks discussed above. The one or more central processing units 304 are connected to a storage 306, where the storage can contain information relating to the service networks supported by the access point 300, for example.

The wireless access point 300 also includes network interfaces 308, including a wireless interface and an interface to a backbone network or other construct that interconnects multiple access points.

The above has described mechanisms and techniques to more efficiently advertise information regarding service networks supported by an access point. In another aspect according to some embodiments, sizes of messages (such as beacon frames, including any of the beacon frames discussed above) can be reduced by compressing portions of such messages. One portion of a message sent between mobile stations and access points that can be compressed is an SSID (Service Set Identifier) field, which is used to identify a particular virtual wireless access network. The compression of the SSID can be accomplished by hashing the SSID to produce a hash value that is smaller than the SSID. Hashing effectively converts an SSID string into a hash value that has a shorter length.

For example, an SSID string can be 32 bytes long. Hashing the SSID can produce a hash value that is 2 or 4 bytes in length. Note that hash values are not unique such that there is a possibility of two SSIDs hashing to the same hash value. This is referred to as a hash collision, which requires a follow-up procedure to resolve the hash collision. When a mobile station detects a hash value in a message that matches a hash value of interest to the mobile station, the mobile station can perform a follow-up procedure to resolve whether or not an actual match has occurred.

For example, upon detecting a matching hash value, the mobile station can send a query (e.g., a probe request) to the access point, where the query contains the actual SSID of interest to the mobile station. The access point can then send a response to indicate whether or not an actual SSID match has occurred. If a match is indicated, then the original message (e.g., beacon frame) received by the mobile station is of interest to the mobile station. However, if a match is not indicated, then the mobile station can discard the original message.

In an alternative embodiment, instead of using hashes, fingerprints can be used instead, where SSIDs are mapped to corresponding fingerprints. A benefit of fingerprints is that they are unique-however, the uniqueness comes at the expense of the fingerprints being longer in length than hash values.

Instructions of software (e.g., software 302 in FIG. 3) for performing various tasks above can be loaded for execution on a processor (e.g., one or more CPUs 304 in FIG. 3). The processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method to advertise capabilities of a wireless access point, comprising:
communicating, from the wireless access point to a mobile station, messages at plural levels of detail to advertise that the wireless access point supports a plurality of service networks,
wherein the messages at the plural levels of detail include a first message indicating that the wireless access point supports multiple service networks, and a second message containing information identifying the plurality of service networks.

2. The method of claim 1, further comprising communicating, between the wireless access point and the mobile station, time information indicating when the second message will be communicated.

3. The method of claim 2, wherein communicating the time information comprises communicating the time information in the first message.

4. The method of claim 1, wherein the first message is communicated more frequently than the second message, and wherein the first message is smaller in size than the second message.

5. The method of claim 1, wherein the messages at the plural levels of detail further include a third message at a detail level between detail levels of the first and second messages.

6. The method of claim 5, wherein the third message is sent more frequently than the second message but less frequently than the first message.

7. The method of claim 1, wherein communicating the messages comprises communicating a hashed value of a service set identifier in one of the messages.

8. The method of claim 1, wherein communicating the messages comprises the wireless access point sending the messages to the mobile station.

9. The method of claim 1, wherein communicating the messages comprises the mobile station receiving the messages from the wireless access point.

10. The method of claim 1, wherein communicating the second message comprises communicating a Generic Advertisement Service (GAS) query response.

11. The method of claim 1, wherein communicating the messages comprises communicating the messages from a Wi-Fi access point to the mobile station.

12. The method of claim 1, wherein the mobile station is able to learn about information of the plurality of service networks in a passive manner.

13. A wireless access point, comprising:
a wireless interface to communicate wirelessly with a mobile station;
a processor to:
determine service networks supported by the wireless access point;
send, to the mobile station, messages at plural detail levels to advertise that the wireless access point supports the service networks,
wherein the messages at the plural detail levels include a first message indicating that the wireless access point supports multiple service networks, and a second message containing information identifying the service networks.

14. The wireless access point of claim 13, wherein the processor is configured to send the messages at the plural detail levels without requiring any query from the mobile station such that the mobile station is able to learn about the service networks in a passive manner.

15. The wireless access point of claim 14, wherein the first message contains time information indicating when the second message will be sent.

16. The wireless access point of claim 15, wherein the first message is smaller in size than the second message.

17. The wireless access point of claim 16, wherein the first message is sent more frequently than the second message.

18. An article comprising at least one computer-readable storage medium containing instructions that when executed cause a mobile station to:
receive, from a wireless access point, messages at plural detail levels to advertise that the wireless access point supports a plurality of enhanced capabilities,
wherein the messages at the plural detail levels include a first message indicating that the wireless access point supports multiple enhanced capabilities, and a second message containing detailed information about the plurality of enhanced capabilities

19. The article of claim 18, wherein the instructions when executed cause the mobile station to receive, from the wireless access point, time information indicating when the second message will be communicated.

20. The article of claim 18, wherein the first message is smaller than the second message, and the first message is sent more frequently than the second message.
